(19) United States
(12) Patent Application Publication
(10) Pub. No.: US 2020/0167820 A1
(43) Pub. Date: May 28, 2020

(54) A METHOD OF DENYING DUPLICATE REWARD FOR DISSEMINATION OF INFORMATION, AND A SYSTEM THEREOF FOR MONITORING PURCHASER-RELATIONSHIP

(71) Applicant: OneQR Limited, Kowloon (HK)

(72) Inventor: Zhiren Kevin Sunny Godfrey Chua Sing SUN, Kowloon (HK)

(21) Appl. No.: 16/637,209

(22) PCT Filed: Mar. 25, 2019
(86) PCT No.: PCT/CN2019/079559

§ 371 Date: Feb. 6, 2020

(30) Foreign Application Priority Data
Mar. 28, 2018 (HK) 18104302.5

(51) Int. Cl. G06Q 30/02; G06Q 50/00

(52) U.S. Cl. CPC G06Q 30/0248; G06Q 50/01; G06Q 30/0215; G06Q 30/0267

(57) ABSTRACT

A method of identifying any repetitive attempts to click onto advertisement banners is disclosed. The method identifies second attempts in order to disregard such second attempts. Hence, all the first attempts maybe identified and suitably rewarded. An accompany system is also disclosed, comprising QR codes which may be scanned by smartphones to trigger a chain of advertisement or rebate coupons. These advertise-ment or rebate coupons may be disseminated to as many users as desired without being counted twice for any same recipient.

### FIELD OF INVENTION

The present invention relates to the technical field of blockchain systems. In particular, the invention relates to purchase digital marketing and reward systems which are implemented on blockchain systems.

### BACKGROUND OF THE INVENTION

Typically, digital marketing is executed by placing advertisement banners on webpages, such as on the websites of social-media-platforms. Businesses pay advertising agencies according to the count of clicks that people who browse the websites make on the banners. However, digital marketing strategy is generally seen as ineffective as there is little or no correlation between the intensity of digital marketing activity and the resultant revenue it brings to the advertised business.

The count of user-clicks to be paid for is reported by advertisement agencies themselves. However, this means that business owners may tend to be suspicious that the count has been inflated. This is not without basis, as unscrupulous advertisers have been known to use bots (software robots) to automatically and repetitively click on banners displayed on websites, masquerading as human users.

Some advertisers have even been known to pay real people to click on the same banners repeatedly. Such fake clicks or ‘phantom clicks’ inflate digital marketing costs and the business owners are never ready sure of the extent of the success of their digital marketing. Unfortunately, it is not possible for businesses to verify whether the number of clicks reported by advertisers is a genuine count of clicks which were made by real human, and that the number does not include repeat clicks.

In addition, many Internet browsing software programs comprise functions known as advertisement blockers. The creation of such functions is a backlash against incessant and indiscriminate advertising. If advertisers are more prudent about sending advertisement only to suitable consumers, consumers may be more receptive to receiving advertisements. Unfortunately, this is not the case.

Accordingly, it is desirable to provide technology to overcome the above described short-comings in digital marketing, and to improve the cost effectiveness of digital marketing.

### SUMMARY OF THE INVENTION

In a first aspect, the invention proposes a method of denying duplicate reward for dissemination of information comprising the steps of: providing a digital token on the social-media-platform account of a user, the digital token bearing the information; the user forwarding the digital token to a contact in his social-media-platform account, such that if the contact accepts the digital token, the social-media-platform account of the contact is paired with the digital token, wherein a reward is issued to the user each time a social-media-platform account of the contact is paired with the digital token; the user forwarding the digital token to the same contact a second time; identifying the second time as an second attempt to pair the social-media-platform account of the same contact with the digital token, and denying a second pairing of the social-media-platform account of the contact with the digital token.

Hence, any second attempt by the same user at forwarding the same digital token to the same contact may be identified.

If the user sends or forwards the digital token to a contact on the same social media, and if the digital token contains an advertisement, the invention provides the possibility that the merchant may now be confident that the advertising agency responsible for the advertisement may be rewarded only once, and not repeatedly, i.e. duplicate reward is avoided.

Preferably, the method further comprises the step of issuing or paying an amount in digital currency to the user as the reward, provided that an attempt to pair the social-media-platform account of the contact with the digital token is not identified as a second attempt.

Optionally, if the attempt is not identified as a second attempt, the amount in digital currency is issued immediately to the user. Alternatively, a percentage of the amount is held in escrow until a conversion occurs, i.e. a purchase of a product is made based on or with reference to the digital token. Advantageously, this helps to control reward pay out, as the reward is paid to the user only when the merchant has made a sale.

Typically, the information comprises an advertisement. Alternatively, the information may be a token survey or a rebate coupon that is issued to attract recurrent purchase from consumers.

Accordingly, the invention provides that advertisers are not rewarded for phantom clicks, and people who help propagate the advertisement are also not given duplicate rewards.

Preferably, records of the digital token are maintained in a blockchain. Advantageously, the blockchain allows every transaction to be verified as unique, and any passing or forwarding of the digital token between different people can be traced within the blockchain. As the skilled man knows, blockchain technology allows a record of data to be maintained by a plurality of computers owned by different users of a blockchain system. Hence, the information recorded is reliable and virtually impossible to be amended by hackers.

In a second aspect, the invention proposes a system for monitoring purchaser-relationship comprising: one or more products; each of the one or more products affixed with a machine-readable-code, the machine-readable-code being capable of triggering a wireless communication device to communicate with a server when the wireless communication device reads the machine-readable-code; wherein, the communication with the server comprises communicating information on a social-media-platform account of the user of the wireless communication device and on the product.

Typically, the machine-readable-code is a barcode, such as a OR code.

Preferably, the information on the user of the wireless communication device includes information on a social-media-platform account of the user. Examples of a social-media-platform include WeChat™, Instagram Facebook™ and Linkedin™,

Preferably, the server is configured to issue a digital token to the user's account on the social-media-platform; the digital token capable of being forwarded to other accounts on the social-media-platform and the server capable of recording the propagation of the digital token to the other accounts,

This provides the advantage of being able to track which of the other users on the social-media-platform has been contacted and sent the digital token. Any attempt at sending the same user the same digital token a second time can be caught. This provides the possibility of identifying such second time attempts, and rewarding only those attempts which are not second time attempts.

Typically, these accounts are on the same social-media-platform, although cross social-media-platform forwarding is also possible. As the skilled man knows, cross social-media-platform forwarding is possible through decentralized digital-wallet to digital-wallet offline transfer. In this case, a user's different accounts in different social-media-platforms can be matched based on their digital wallet transactions. Typically, the wireless devices are smartphones.

Preferably, the machine-readable-code contains information which allows the identification of the merchant who made or provided the product. For example, the machine-readable-code may contain product information, product serial number and/or serialized UPC (Universal Product Code) of the product, which allow tracing to the merchant. This may provide greater confidence in product authenticity.

Typically, the digital token is stored in what is known as a digital wallet or e-wallet, which is simply a record of the digital token in a blockchain system. This provides that control and management of the digital token is not in the hand of any one person maintaining or who owns a server containing records of the digital token, thereby reducing information theft or unlawful record amendment.

As the digital token was affixed to the product, the digital token can also be used to trace the transfer of ownership of the product. Any change in ownership of the product may be followed by a transfer of the digital token from the digital wallet of the first owner to the digital wallet of the second owner. Hence, movements and ownership of the product can even be traced between manufacturers and distributors.

In some embodiments, the digital token is an ‘asset-token’ known as a Product E-Certification of Authenticity (PECA). In some embodiments, the PECA may contain a GS1 standard UPC product identification specification. Since this GS1 standard is the global standard used on 95% of global products, its use virtually assures the consumer that the product is the only one in the world.

In a third aspect, the invention provides a method of identifying a second attempt in receiving information in a social-media-platform comprising the steps of: displaying a digital token in the account of a user in an interface of a social-media-platform, the digital token comprising the information; determining if the digital token has been paired to the account of the user in a social-media-platform when a user interacts with the digital token; pairing the digital token to the account of the user in the social-media-platform if the digital token has not been paired to the account of the user in social media; or disregarding the user interaction if the digital token has been paired to the account of the user in social media.

Preferably, the user interaction with the digital token comprises using clicking on the displayed token.

In a fourth aspect, the invention proposes a digital picture for display on a social-media-platform in a smartphone, the digital picture comprising: a digital token which is initiated by a user for a merchant; the digital token being responsive to use of the smartphone to verify a product sold by the merchant, such that on verification of the product, the digital token triggers payment of a commission to the user.

Typically, the digital picture is posted onto a social-media-platform app in a smartphone, such as WeChat™, to be responsive to the use of the smartphone to verify the product. Preferably, the same digital picture is capable of being used over a plurality of social-media-platforms including, for example, WeChat™ Facebook™ Instagram™ and so on.

### BRIEF DESCRIPTION OF THE FIGURES

It will be convenient to further describe the present invention with respect to the accompanying drawings that illustrate possible arrangements of the invention, in which Ike integers refer to like parts. Other arrangements of the invention are possible, and consequently the particularity of the accompanying drawings is not to be understood as superseding the generality of the preceding description of the invention.

FIG. 1 is an illustration of a system, being an embodiment of the invention;

FIG. 2 illustrates a product purchased by a consumer, being part of the embodiment of FIG. 1;

FIG. 3 illustrates a QR code used in the embodiment of FIG. 1

FIG. 4 illustrates the product of FIG. 1 with the OR code revealed;

FIG. 5 illustrates the interface of a social-media-platform which is used in the embodiment of FIG. 1; and

FIG. 6 is a flowchart of a process describing how to use the embodiment of FIG. 1;

FIG. 7 illustrates a user interface of a reward-app (software) of the embodiment of FIG. 1;

FIG. 8 illustrates the syntax of a link embedded in the digital token or banner of the third embodiment;

FIG. 9 illustrates another interface of the reward-app of FIG. 7;

FIG. 10 illustrates another interface of the reward-app of FIG. 7;

FIG. 11 illustrates another interface of the reward-app of FIG. 7;

FIG. 12 illustrates another interface of the reward-app of FIG. 7;

FIG. 13 illustrates another interface of the reward-app of FIG. 7;

FIG. 14 illustrates another interface of the reward-app of FIG. 7;

FIG. 15 illustrates another interface of the reward-app of FIG. 7;

FIG. 16 illustrates another interface of the reward-app of FIG. 7;

FIG. 17 illustrates another interface of the reward-app of FIG. 7;

FIG. 18 illustrates another interface of the reward-app of FIG. 7;

FIG. 19 illustrates another interface of the reward-app of FIG. 7;

FIG. 20 illustrates another interface of the reward-app of FIG. 7;

FIG. 21 illustrates another interface of the reward-app of FIG. 7;

FIG. 22 illustrates another interface of the reward-app of FIG. 7;

FIG. 23 illustrates another interface of the reward-app of FIG. 7;

FIG. 24 illustrates another interface of the reward-app of FIG. 7;

FIG. 25 illustrates another interface of the reward-app of FIG. 7;

FIG. 26 illustrates another interface of the reward-app of FIG. 7;

FIG. 27 illustrates another interface of the reward-app of FIG. 7;

FIG. 28 illustrates an interface of the embodiment of FIG. 1, meant for use by a merchant;

FIG. 29 illustrates yet a further interface of the embodiment of FIG. 1 meant for use by a merchant;

FIG. 30 illustrates yet a further interface of the embodiment of FIG. 1 meant for use by a merchant;

FIG. 31 shows a user using a prototype of a third embodiment;

FIG. 32 shows a user using a prototype of the embodiment of FIG. 31;

FIG. 33 shows a user using a prototype of the embodiment of FIG. 31;

FIG. 34 shows a user using a prototype of the embodiment of FIG. 31;

FIG. 35 shows a user using a prototype of the embodiment of FIG. 31;

FIG. 36 shows a user using a prototype of the embodiment of FIG. 31;

FIG. 37 shows a the relationship between users of the embodiment of FIG. 31;

FIG. 38 also shows a the relationship between users of the embodiment of FIG. 31;

FIG. 39 shows the full third embodiment and the relationships between all the parties; and

FIG. 40 shows a screen which pops up in the third embodiment.

### DETAILED DESCRIPTION OF EMBODIMENTS

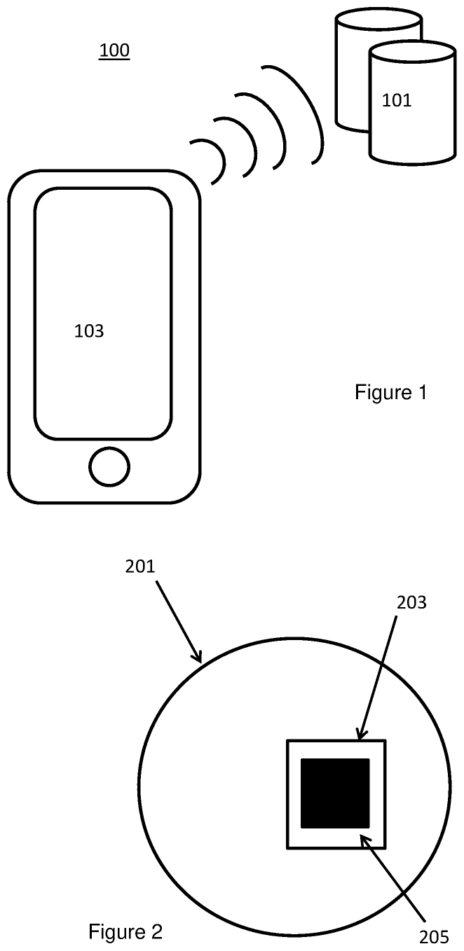

FIG. 1 shows a system 100 for sending digital marketing information to consumers, specifically, to the computers or smartphones 103 of consumers. ‘Smartphones’ 103 refers to portable, hand-held telephones which operate wirelessly (as illustrated by the ‘waves’ in the drawing), and which comprises computing capabilities allowing user interaction, smartphone 103 location detection, and software (app) installation for providing functions including surfing the Internet. Typically, a smartphone 103 is provided with an inbuilt camera which can be used to take photographs or scan a barcode. Also, a smartphone 103 tends to be provided with a touch-sensitive display screen for user interaction with display content. A prominent example of a smartphone 103 is the iPhone™ produced by Apple Inc.

The system 100 comprises a server 101 in communication with a plurality of computers or smartphones 103. The drawing illustrates only one smartphone 103 for simplicity, but the skilled reader would understand that the same interaction is provided between a number of smartphones 103 (and/or computing devices) and the server 101.

A consumer buys a product 201 of a particular merchant using the system 100. The product 201 is illustrated in FIG. 2. A barcode, preferably a OR-code 203 (abbreviated from Quick Response Code), is attached or affixed to the product 201. This ensures that the OR-code 203 is secured to the specific product 201 and cannot be mistaken as a OR-code 203 for another product 201.

A OR-code 203 is a two-dimensional barcode. The OR-code 203 is a machine-readable optical label and may be read by suitable software in a smartphone 103 through the smartphone's camera. Typically, the OR-code 203 contains an Unique Serial ID storing authentication information on the specific product 201. The specific details of a OR-code 203 are known to the skilled man and further elaboration herein is not necessary.

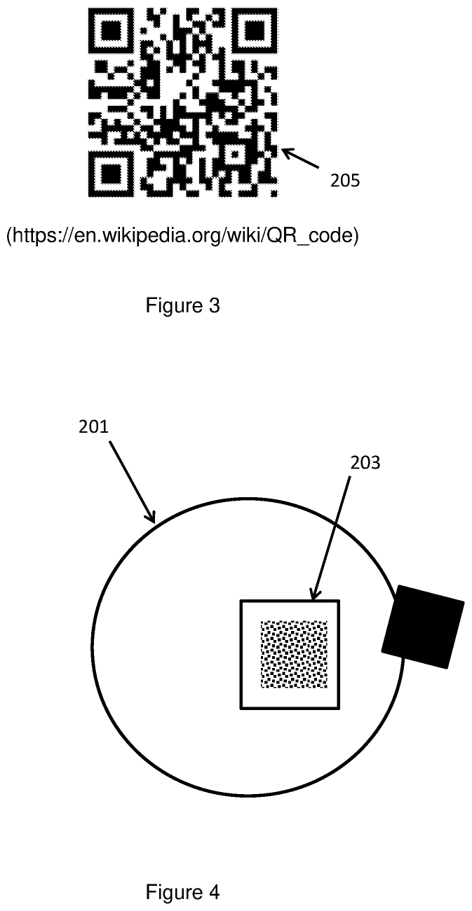

FIG. 3 shows a typical OR-code 203 taken from a webpage of the website www.wikipedia.org. Any other form of machine readable code may be used, however. For example, the machine readable code may be in the form of Holographic QR Labels which requires special printing methods, such as those provided by GS1, for improved security against barcode counterfeits. The conventional barcode label may also be used. Alternatively, a two-dimensional or three-dimensional Augmented Reality barcode may be used. An example of a well-known three-dimensional Augmented Reality barcode is the Pokémon Go™ game which has attracted users to hunt for three dimensional digital creatures which appears on the screen of smartphones as the smartphones are used by their owners to interact with real environment.

GS1 or Global Standards One is a well-known, not-for-profit organisation that develops and maintains global standards for business communication, including barcode standards, GS1 does not require introduction here.

The OR-code 203 on the product 201 is concealed by an opaque sticker 205 laid over the OR-code 203. In this particular embodiment, only when the consumer has peeled off the opaque sticker 205 after buying the product 201 would the OR-code 203 be revealed for scanning by a smartphone 103. Hence, a consumer who notices that the concealment of a OR-code 203 has been tempered with may reject the product 201 on suspicion that the product 201 is not genuine. Alternatively, in other embodiments, the concealment is provided as a scratch-off label, revealing the OR-code 203 only when a layer of concealment has been scratched off. Yet more alternatively, the concealment is hard plastic (not necessarily opaque) product seal. Equivalent technologies are known to the skilled man and there is also no need to elaborate on them here.

FIG. 4 illustrate the opaque sticker 205 peeled off to expose the OR-code 203.

After the consumer has scanned the QR-code 203, the consumer sends the scanned OR-code 203 using his smartphone 103 to the server 101 for authentication of the product 201.

The server 101 may be owned by the merchant who sells the product 201, or can be owned by any service provider whom the merchant pays to use the system 100.

In response to the communication by the smartphone 103, the server 101 issues to the smartphone 103 an asset-token and a rebate-coupon-token 301, which will both be instantly stored into the smartphone 103. Preferably, the digital wallet is identified by the consumers account on a social-media-platform.

The asset-token provides authentication of the product 201. Typically, the asset-token is an electronic certificate, named herein as a Product E-Certificate of Authenticity (PECA) token. The PECA token contains information about the product 201 that is useable to certify product authenticity. The certificate may be provided with GS1 validation.

Strictly speaking, it is the OR-code 203 which the server 101 authenticates. Before the product 201 was placed on sale, the OR-code 203 was affixed to the product 201 by the manufacturer or merchant, and the OR-code 203 was already recorded into or pre-registered with a database in the server 101. In this way, product details were pre-recorded against the server's record of the OR-code 203, as paired information. This allows the asset-token sent by the server 101 to the smartphone 103 to include information such as the OR-code serial number, the product's name, type, category, manufacturer, distributor, standardised price and so on. The consumer can be assured of the authenticity of the product 201 by reading this information and ensuring that the information describes the product 201 accurately.

‘Pairing’ may mean simply recording the consumer's social-media-platform account against the record of the OR-code 203 in any way, such as by entering the consumer's social-media-platform account and the record of the OR-code 203 into a database and linking them together.

When received into the smartphone 103, the authentication information provided by the asset-token is displayed on the screen of the smartphone 103. At any time, by clicking or pressing on the asset-token via the touch sensitive screen of the smartphone 103, the consumer is able to review the source and history of the product 201

Typically, the smartphone 103 which the consumer used to scan the OR-code 203 comprises an application or app (a smartphone software program) and the afore-mentioned digital wallet. The app is named the reward-app in this description for clarity. The reward-app's key features include a barcode reading function using the smartphone's camera.

The digital wallet stores the consumers tokens in a blockchain, and also stores the amount of money in a digital currency which belongs to the consumer.

The digital wallet is linked to the consumer's social-media-platform account, i.e. the digital wallet can be identified by and accessed through the customer's social-media-platform account. Examples of such social-media-platform include WeChat™, Instagram Facebook™ and Linkedin™. Other social-media-platforms not mentioned here are also considered included, as the skilled man would appreciate.

Accessing the digital wallet simply requires the consumer to sign in into his social-media-platform account. In other words, the social-media-platform account is used to authenticate the consumer. This makes it easy for the consumer to forward the rebate-coupon-token 301 to as many people among his social-media-platform contacts as he desires. He can even share a photograph of the list of coupons he has in his digital wallet onto the social-media-platform.

The rebate-coupon-token 301 is redeemable as money in a digital currency. Typically, the rebate-coupon-token 301 is issued to the consumer's account in a pre-selected social-media-platform.

The consumer is able to make a new purchase from the same merchant using the rebate-coupon-token 301, using an amount in digital currency represented by the rebate-coupon-token 301 as all or part of payment. When the server 101 issues the rebate-coupon-token 301, the server 101 links the identification of the product 201 which the consumer has just bought, the consumer's smartphone number (and optionally the smartphone's IMEI, or the smartphone's oauth), the consumer's social-media-platform consumer identity, and the identification of the rebate-coupon-token 301 as paired records.

The rebate-coupon-token 301, however, is also capable of being forwarded to other people. More specifically, the consumer can forward the rebate-coupon-token 301 to people in the contact list of his social-media-platform. By ‘forwarding’, it means the consumer clicks onto the rebate-coupon-token 301 as displayed in the social-media-platform and selects people in his contact list on his social-media-platform. Subsequently, an image of the rebate-coupon-token 301 will be displayed on the interface of the social-media-platform of the contacts to whom the consumer has forwarded the rebate-coupon-token 301, i.e. the receiving contacts. The consumer does not necessarily have to use the smartphone 103 to do so. Any computing device which displays the website or interface of the social-media-platform may be used by the consumer to forward the rebate-coupon-token 301.

As the rebate-coupon-token 301 is in a digital format, a copy of the rebate-coupon-token 301 can be created in each of the receiving contact's digital wallet, which is also linked to the receiving contact's social-media-platform account. The receiving contacts may see the same rebate-coupon-token 301 on their social media. However, in effect, the rebate-coupon-token 301 is re-issued by the server 101 to each receiving contact. Each re-issuance of the rebate-coupon-token 301 can be identified by a unique serial number and paired with the specific receiving contact. This ensures that use of the copy of the rebate-coupon-token 301 can be traced specifically to each receiving contact. However, each receiving contact must ‘accept’ the rebate-coupon-token 301 by manually clicking onto the display of the rebate-coupon-token 301 shown on his social-media-platform. Only when the receiving contact has accepted the rebate-coupon-token 301 would that receiving contact be able to use the rebate-coupon-token 301 for making a purchase from the same merchant.

Technically, clicking on the image invokes an embedded link to the digital wallet of the potential consumer. The option to accept is in the receiving contact's digital wallet.

When a receiving contact clicks on the rebate-coupon-token 301 to accept it, it is assumed that consent has been given for the merchant to collect the receiving contact's personal information.

Generally, the manner in which a merchant collects a contact's personal information, and how the merchant gives rebate or rewards, whether in terms of cash, loyalty points and so on, is established in ‘smart contracts’. As the skilled person knows, smart contracts are electronic contracts implemented in computer code which are automatically generated, stored and managed in a blockchain. Smart contracts are well known in the art and have no need of elaboration here.

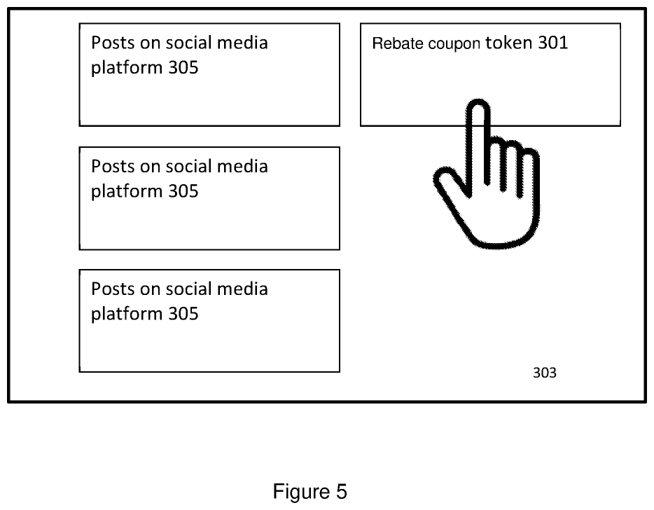

As a result, a software function hidden in the rebate-coupon-token 301 causes the receiving contact's social-media-platform information and smartphone 103 information to be sent to the server 101. Accordingly, the receiving contact's social-media-platform account, his smartphone 103 and his personal information will be recorded against the rebate-coupon-token 301 in the server 101. The finger shown in FIG. 5 illustrates a receiving contact clicking onto a rebate-coupon-token 301 on the website 303 of his social-media-platform, in order to accept the rebate-coupon-token 301. The rebate-coupon-token 301 is displayed next to other posts 305 or conversations the consumer has with his social-media-platform contacts, as is typical for such social-media-platform websites.

The unique serial number of each issue of rebate-coupon-token 301 ensures that the rebate-coupon-token 301 cannot be stolen or abused by any person easily, since the receiving contact has been paired to the rebate-coupon-token 301.

Each time the consumer forwards the rebate-coupon-token 301 to one of his receiving contacts, and when any one of the receiving contacts accepts the rebate-coupon-token 301, the consumer earns a referral reward. Furthermore, each time a receiving contact forwards in turn the rebate-coupon-token 301 to one of his own social-media-platform contacts, and when any of his own social-media-platform contacts accepts the rebate-coupon-token 301, the receiving contact also earns a referral reward. This encourages dissemination of the rebate-coupon-token 301, as one person forwards the rebate-coupon-token 301 to another person in a chain of forwarding actions.

The reward may be, for example, a cash rebate in any digital currency. The condition of the reward is set in the smart contract.

Preferably, the reward is paid out partially and a remaining amount is held in escrow. The escrow amount will be released when there is a ‘conversion’. For example, a partial payment of 30% in a digital currency may be made as reward to the consumer who forwarded the rebate-coupon-token 301 to the receiving contact. If and when the receiving contact uses the rebate-coupon-token 301 to purchase a product 201 from the merchant, i.e, made a conversion, the remaining 70% which has been held in escrow is paid too.

All the preceding contacts in the chain who forwarded the rebate-coupon-token 301, starting from the consumer who first bought the product 201 to the contact who made the conversion, are given a further reward. This encourages the consumer and all his receiving contacts to disseminate the rebate-coupon-token 301 selectively, mainly to those contacts who are likely to use the rebate-coupon-token 301 to make a purchase.

For avoidance of doubt, it should be noted that as far as the consumer and the receiving contacts are concerned, the rebate-coupon-token 301 disseminated in the chain is the same to all of them. The unique serial number of each re-issued rebate-coupon-token 301, which each receiving contact receives, is only for tracking each particular receiving contact, and do not constitute a new rebate-coupon-token 301.

An example will now be given to elaborate on how the amount of reward money is distributed to all the receiving contacts in the chain: Tom scans the OR-code 203 affixed to the product 201 which Tom has purchased, and receives the rebate-coupon-token 301. Tom then forwards the rebate-coupon-token 301 to Peter, who is among Tom's social-media-platform contacts. Peter accepts the rebate-coupon-token 301 and Peter's personal information on the social-media-platform is sent to the server 101. By the same mechanism, Peter forwards the rebate-coupon-token 301 to Paul, and Paul forwards the rebate-coupon-token 301 to Jane. If, for example, a ‘primary reward’ is $1 and a ‘secondary reward’ is $0.50 cents, then Tom being the consumer who bought the product 201 stands to receive the primary reward of $1 when the rebate-coupon-token 301 undergoes conversion, and everyone else in the chain will stand to receive the secondary reward of $0.50. However, to safeguard the system 100 from making a financial loss, only a portion of the primary reward of $1 is paid to Torn, and no secondary reward is paid to each person in the chain if there is no conversion. That means, only when any one of the receiving contacts in the forwarding chain uses the rebate-coupon-token 301 to buy a product 201 from the merchant would the full reward due to everyone be issued completely. Therefore, if Jane purchases a product from the merchant, the rest of the due amount held in escrow is paid to everyone in the chain preceding Jane. The rebate-coupon-token 301 has been redeemed for Jane. Such a system 100 would cause the different people in the chain to encourage one another to use the rebate-coupon-token 301.

Furthermore, if Torn forwards the rebate-coupon-token 301 to a John, a Dick and a Harry, Tom will stand to receive $3 in total ($1 for each of John, a Dick and a Harry) for initiating three forwarding chains, provided that all three chains undergo conversion.

Propagation and record of the rebate-coupon-token 301 is managed by blockchain technology in the same way as digital currency such as Bitcoin is managed. As the skilled reader knows, blockchain technology allows information to be stored and distributed in a peer-to-peer network, but not copied or modified. Very simply, a blockchain record is like an open record that everyone can see and is shared amongst all its consumers. All the people using the blockchain keep the record up-to-date in each of their computers. Every additional person who received the rebate-coupon-token 301 is added to the record block as part of a chain, i,e. account or digital wallet detail of the latest computer or person receiving the rebate-coupon-token 301 is appended to a record of all past transactions. Each chain can only be appended to, but not re-written or changed. Therefore, to change the history of the transaction of a rebate-coupon-token 301, the records would have to be changed in the majority of participating computers. With the sheer number of receiving contacts who has passed on the rebate-coupon-token 301 in the chain, changing the history of a rebate-coupon-token 301 is impossible.

The possibility offered by the embodiment is to assist merchants or businesses to create incentives to promote consumer loyalty while at the same time provide functions such as monitor, survey and record the propagation of the promotion to reach out to as much possible consumers with the ability to realize a real conversion.

Data tracking the forwarding of the rebate-coupon-token 301 from the consumer to every receiving contact in the chains can be collected to identify trends in consumer behaviour for the particular products 201 of the merchant.

Accordingly, the described embodiment provides the possibility of using barcodes to identify the product 201 by label. Generally, many consumers would not have cared to authenticate the products 201 they bought. However, as consumers of the embodiment get paid to scan the barcode, the embodiment encourages the consumers to authenticate the product 201 which increases the merchant's surveillance on counterfeit and fake goods. This is particularly important to merchants who are selling goods that could have serious health and safety implications if the goods were fake or counterfeit, such as food, herbs and medicine.

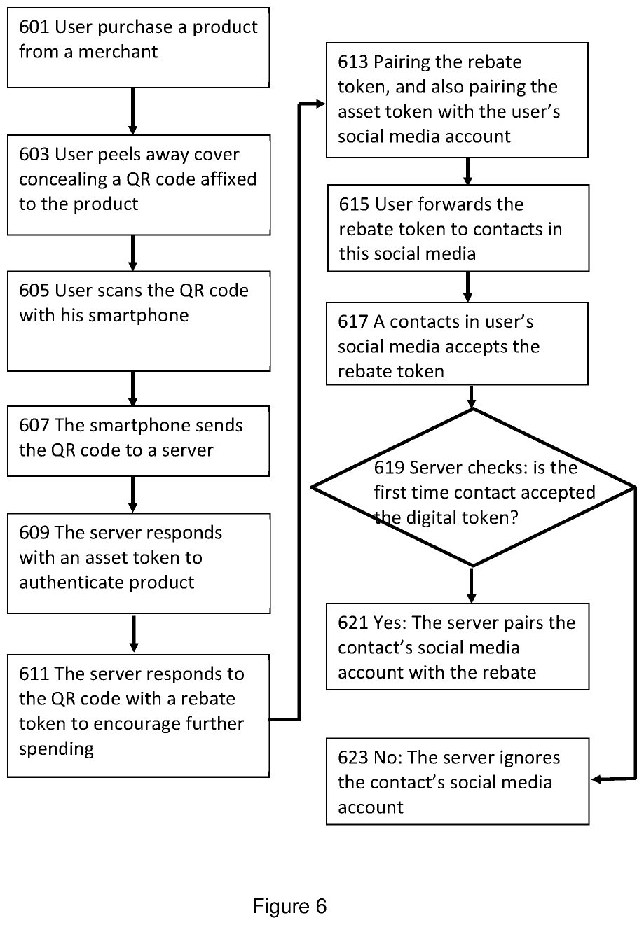

FIG. 6 is a flowchart illustrating use of the embodiment of FIG. 1. In step 601, the consumer purchases a product 201 from the merchant. In step 603, the consumer peels away cover concealing a OR-code 203 affixed to the product 201 (see FIG. 4). In step 605 the consumer scans the OR-code 203 with his smartphone 103, In step 607, the smartphone 103 sends the OR-code 203 to a server 101. In step 609, the server 101 responds with an asset-token to authenticate the product 201. At the same time, in step 611, the server 101 responds to the OR-code 203 with a rebate-coupon-token 301 to encourage further spending. In step 613, the server 101 pairs the rebate-coupon-token 301, and also the asset-token with the consumer's social-media-platform account,

In step 615, the consumer forwards the rebate-coupon-token 301 to contacts in his social media. In step 617, a receiving contact in consumer's social-media-platform accepts the rebate-coupon-token 301. In step 619, the server 101 checks whether this is the first time the receiving contact has accepted the same rebate-coupon-token 301. As described, each re-issuance of the same rebate-coupon-token 301 is identifiable by a unique serial number. If this is the first time the receiving contact has accepted the rebate-coupon-token 301, in step 621, the server 101 pairs the receiving contact's social-media-platform account with the rebate-coupon-token 301. If not, the step 623, the server 101 ignores the receiving contact's social-media-platform account as there is no need to pair the account with the same rebate-coupon-token 301 (albeit a re-issued one).

Optionally, the rebate-coupon-token 301 bears an advertisement message when it is displayed in the social-media-platform of the receiving contacts. Every time the server 101 pairs a rebate-coupon-token 301 with a social-media-platform account, the server 101 counts the pairing towards a payment to be made to the advertisement agency or the advertising platform (not illustrated in flowchart).

Furthermore, every time the server 101 pairs a rebate-coupon-token 301 with a social-media-platform account, the server 101 counts the pairing towards a payment to be made to the consumer who forwarded the rebate-coupon-token 301 to the receiving contact (not illustrated in flowchart). This will encourage consumers of the embodiment to send the rebate-coupon-token 301 to their social-media-platform receiving contacts, i.e. share or forward the rebate-coupon-token 301, especially those who are likely to accept the rebate-coupon-token 301.

Forwarding or sharing can also be done offline through digital wallet to digital wallet share as long as both digital wallets are logged into a social media, as the system 100 can identify and create a network connection based on digital wallet address and who owns the digital wallet.

Typically, the rebate-coupon-token 301 provides the receiving contacts accepting the rebate-coupon-token 301 with a rebate if the receiving contacts make a purchase with the merchant issuing the rebate-coupon-token 301. This will help to encourage dissemination of the rebate-coupon-token 301, and generate business for the merchant.

Accordingly, the embodiment provides that the merchant is in full control of the way data on the effectiveness of his advertisement is gathered. Unlike prior art method of counting clicks, the merchant now counts the number of unique social-media-platform accounts matched to each one of the rebate-coupon-tokens 301 he has issued.

In a second embodiment, a merchant simply issues an advertising token to potential consumers. The advertising token is just a digital token but it does not carry any rebate value. Optionally, there is no need for any consumer to have first bought a product 201 and scan a QR-code 203 associated with the product 201. The advertising token will be presented on the potential consumer's social-media-platform when the merchant forwards the advertising token to him. Alternatively, as in the first embodiment, the merchant is able to forward an advertisement token to a consumer when the consumer has bought a product. Yet more alternatively, the merchant is able to forward an advertisement to a consumer when the consumer has scanned an Augmented Reality OR code in a departmental store.

The potential consumer can click on the advertising token if he is interested in the advertisement. The potential consumer can also forward the advertising token to his social-media-platform contacts.

Each first-time click on the advertising token by any receiving contact downstream in the forwarding chain provides a reward payment in digital currency to the first potential consumer. At the same time, the receiving contact's social-media-platform information is sent to the server 101.

Therefore, the server 101 is able to identify and count the number of receiving contacts that have clicked on the advertisement, identified by their social-media-platform account. Any repeated clicking onto the same advertising token by a same receiving contact will not be recorded. This provides the possibility that advertisement is only charged for a click by every receiving contact.

Optionally, everyone from the potential consumer and his receiving contacts may receive a reward for simply clicking on the advertisement. A reward may serve to encourage the potential consumer and receiving contacts to click on the advertisement.

Optionally, the potential consumer and his receiving contacts only need to forward the advertisement token to further contacts in the social-media-platform to obtain a reward. This encourages users of the social-media-platform to disseminate the advertisement. A variation of this option is that the potential consumer receives a reward only if a receiving contact to whom he has forwarded the advertisement token has clicked on the advertisement token (already afore-mentioned). This encourages the potential consumer to forward the advertisement token only to people who are likely to be interested in the advertisement. This will help the merchant market to the correct audience, and reduces advertisement spam.

In a variation of this embodiment, the message on the advertisement token changes dynamically. If the smartphone 103 of the consumer is detected to be near the vicinity of a specific store, the consumer will be shown an advertisement of any current promotions. Typically, this would include in the system geo-locating smart devices deployed in retail stores to detect the smartphone 103.

Advantageously, the present system 100 allows merchants to leverage on any blockchain rebate-coupon-token 301 or currency system 100 without having to set up one on their own. The system 100 provides a scalable technology which can accommodate the activities of any new or young merchants, lowering the threshold of any young businesses for joining a blockchain based reward or digital currency system 100.

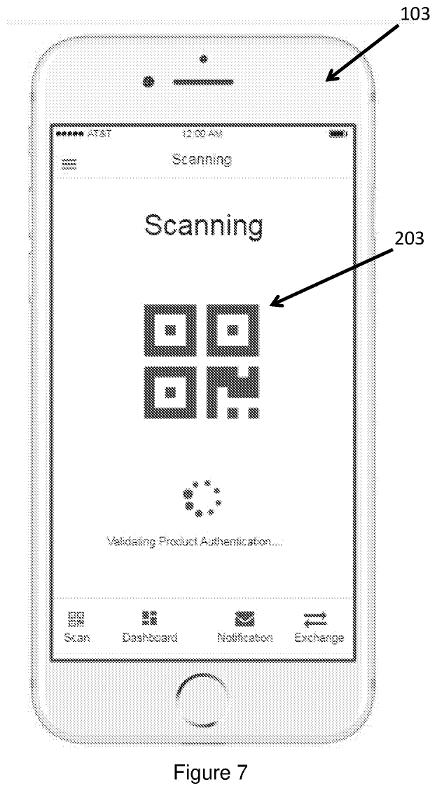

FIG. 7 through to FIG. 29 shows the graphical consumer interface of a reward-app in a smartphone 103, which a consumer uses to engage the embodiments. The drawings are not arranged in the order in which the consumer may consumer the different interfaces of the reward-app.

FIG. 7 shows a OR-code 203 being scanned by an reward-app in a smartphone 103, and being processed by the reward-app. The OR-code 203 is affixed to product 201 as described in the first embodiment, and has to be revealed by removing a concealment preventing scanning. The smartphone 103 reads the OR-code 203 using the camera of the smartphone 103. The interpretation and processing of the OR-code 203 is done by the reward-app. The reward-app is in communication with a server 101, which can identify the OR-code 203 as having been registered with the server 101 for a particular merchant's product 201.

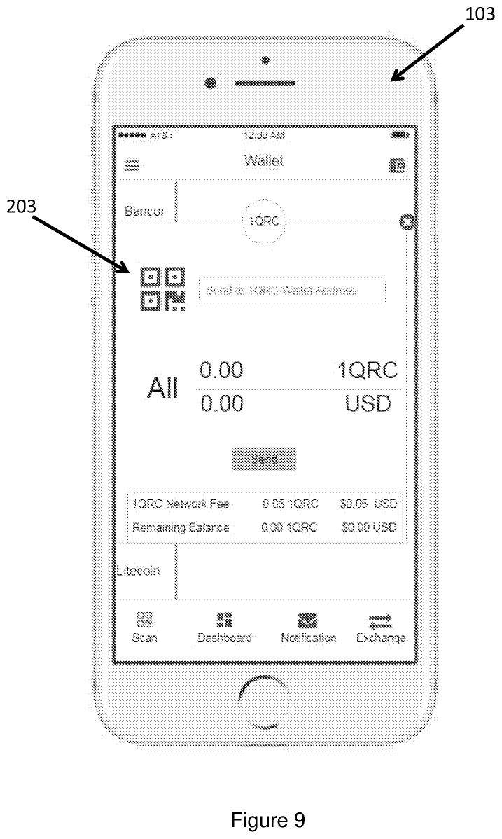

FIG. 9 illustrates the interface by which the consumer can forward or send the OR-code 203 to the server 101.

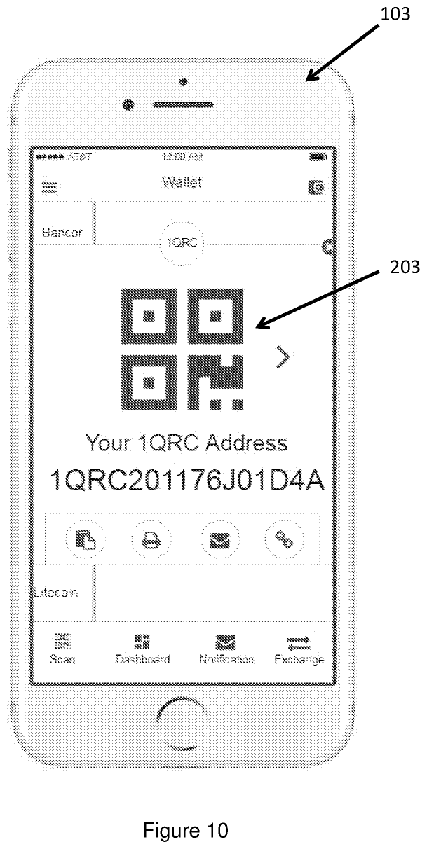

FIG. 10 illustrates the response displayed in the reward-app interface when the QR-code 203 is received by the server 101.

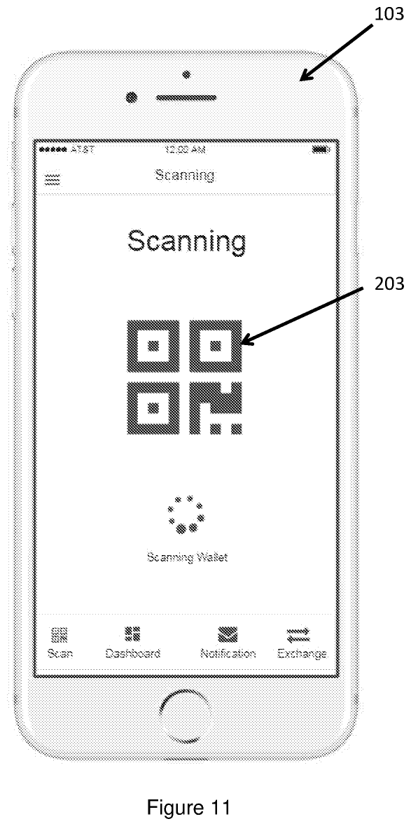

FIG. 11 illustrates the interface of the reward-app when the reward-app is scanning the digital wallet of the consumer. The digital wallet typically resides in the smartphone 103, or may be stored in a server 101 which can be assessed through a network or the Internet. Typically, the digital wallet scanning is triggered by the smartphone 103 scanning a new OR-code 203 on a new purchase product.

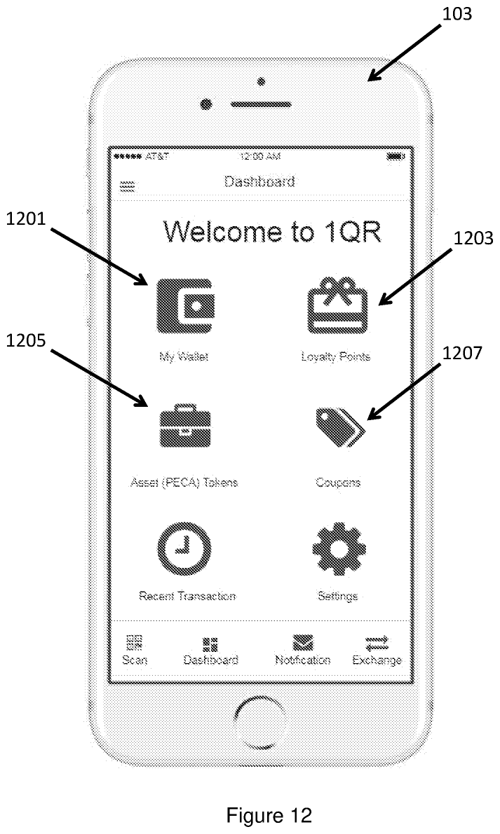

FIG. 12 shows the interface which a consumer, i.e. the owner of the smartphone 103, sees when the consumer has signed in or logged in to the reward-app. The reward-app is named ‘1 QR’ in the drawing. An icon for accessing the digital wallet 1201 is shown, i.e. ‘My Digital wallet’. The use can press on this icon on the touch sensitive screen of the smartphone 103 to open the digital wallet interface, in order to see the amount of digital currency he has in his digital wallet 1201. The other icons include the ‘Loyalty Point’ icon 1203, which may be used to open a folder recording any digital token issued by a merchant in reward to the consumer, and the icon named ‘Asset (PECA) Tokens’ 1205 which opens a folder used to store asset-tokens used for authenticating products 201. The icon ‘Coupons’ 1207 is used to access a folder to store the digital rebate-coupon-tokens 301.

The digital token issued by a merchant in reward to the consumer may be thought of as being like credit card redemption points or air miles awarded by airline companies. These are digital loyalty points which encourage repeat purchase or exchange of physical rewards (like how consumers may exchange their credit card points for products).

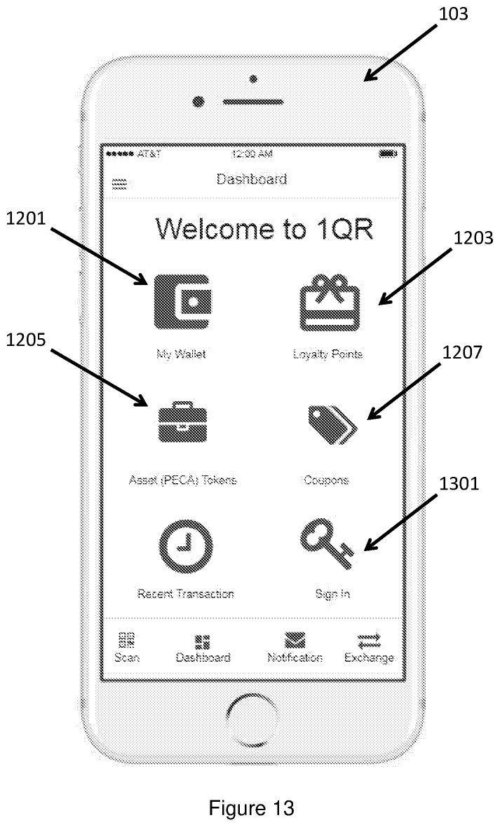

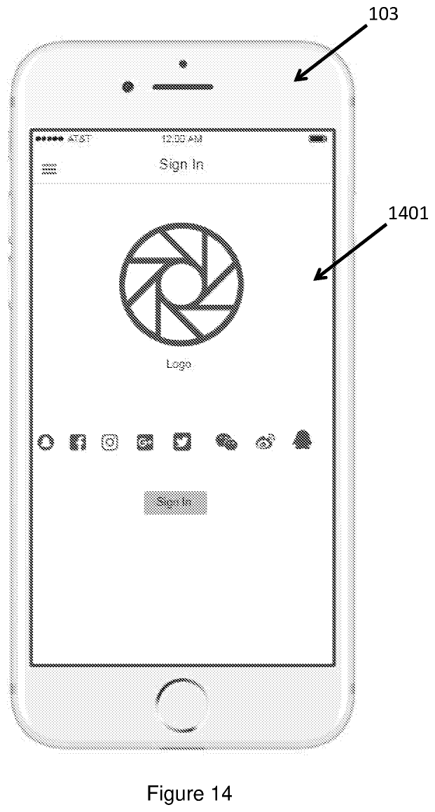

FIG. 13 is a comparative illustration showing the interface of FIG. 12 before the consumer signed in into the reward-app. Before the consumer has signed in, none of the folder icons will respond to the consumer's touch to open up the respective folders. To sign in, the consumer presses on the icon 1301 looking like a key at the bottom right hand of the interface. FIG. 14 illustrates the interface 1401 for signing in into the reward-app.

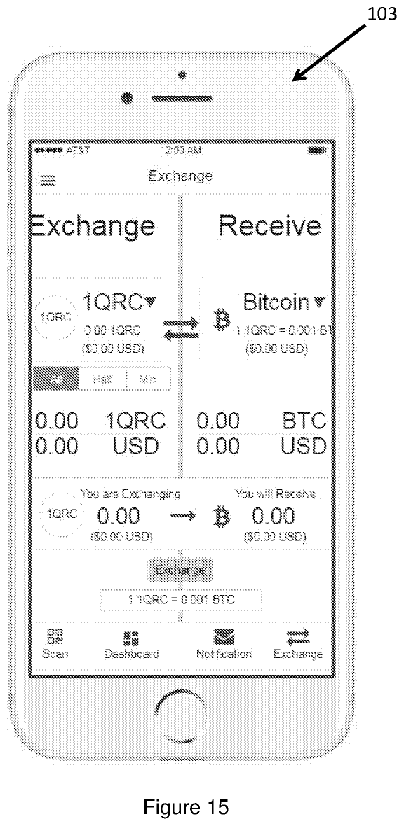

FIG. 15 illustrates the interface which the consumer sees when the exchange any rebate-coupon-token 301 for an amount digital currency, such as Bitcoin. In FIG. 15, the digital rebate-coupon-token 301, and is being exchanged for 0.001 Bitcoin.

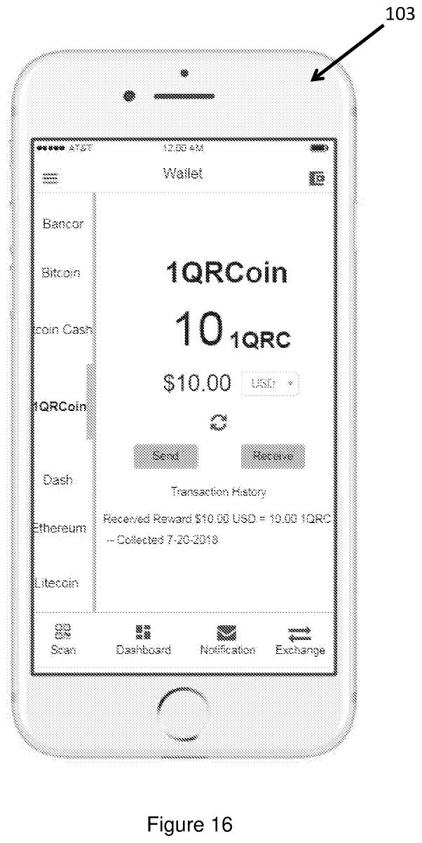

FIG. 16 illustrates the interface of the digital wallet 1201, showing a store of a digital token as a reward, which is worth USD $10. This reward may be received, for example, when one of the receiving contacts which the consumer has forwarded a digital rebate-coupon-token 301 has used the digital rebate-coupon-token 301 to make a purchase.

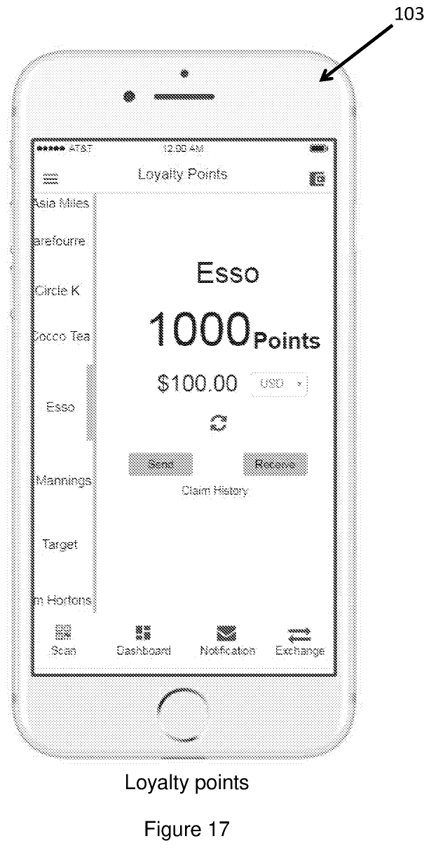

FIG. 17 is the interface of the reward-app showing the amount of loyalty point that the consumer has earned from a single merchant. The merchant illustrated is one known as ESSO.

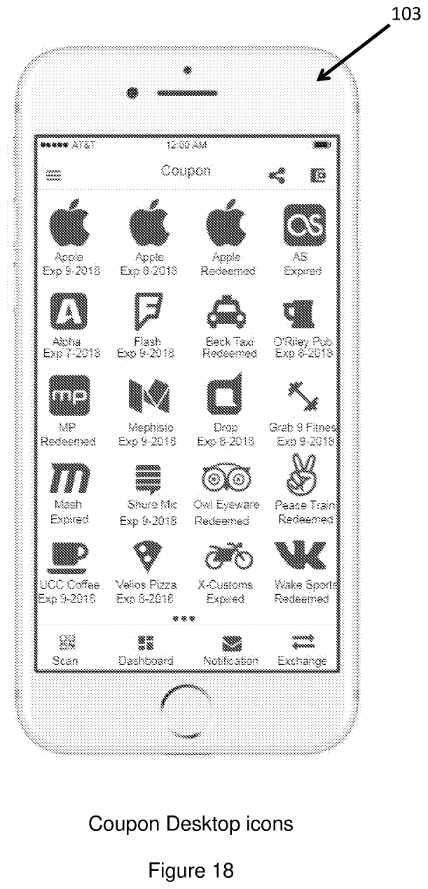

FIG. 18 illustrates that every participating merchant has their own icons which the consumer can press onto to assess a folder containing the rewards and loyalty points of each merchant,

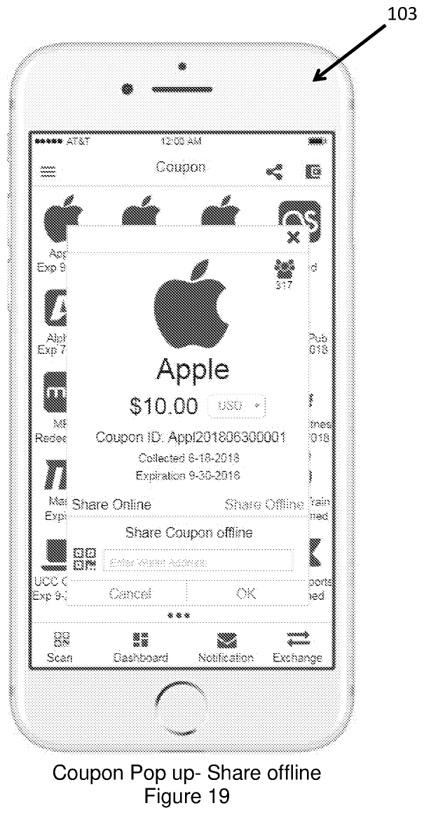

FIG. 19 illustrates the interface of the reward-app by which the consumer can transmit a digital rebate-coupon-token 301 to another consumer in an ‘offline’ mode.

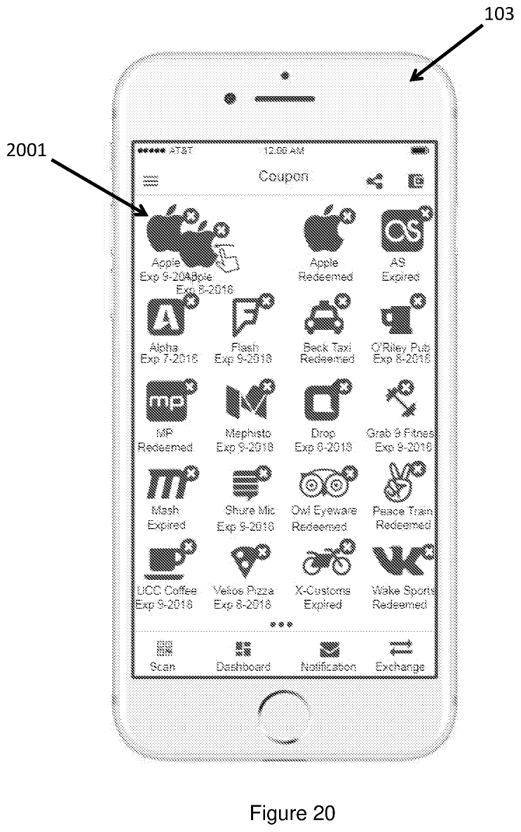

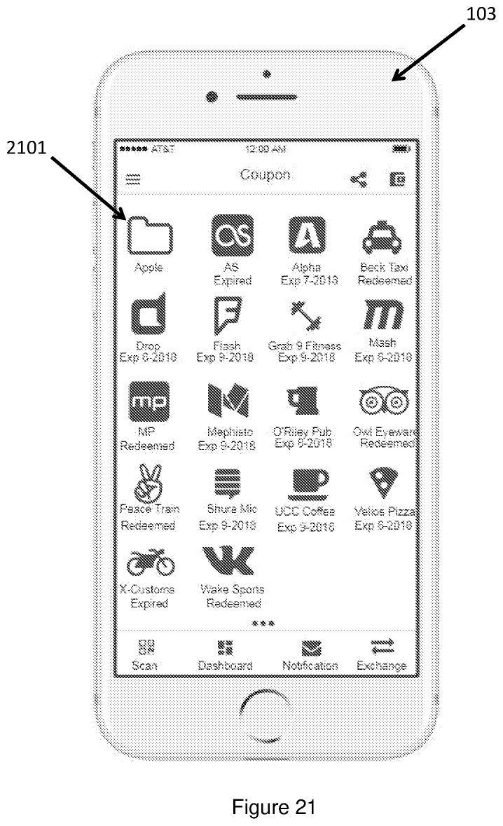

FIG. 20 illustrates that a digital rebate-coupon-token 301 supplied by a merchant can be ‘merged’, at 2001, into another digital rebate-coupon-token 301 to form a folder containing both the two digital coupons. The consumer can ‘dragged and dropped’ a digital rebate-coupon-token 301 issued by Apple Inc., for example, onto another digital rebate-coupon-token 301 issued by Apple Inc., When layered like this, the a folder 2101 is created containing the digital rebate-coupon-tokens 301. The folder formed is illustrated in FIG. 21.

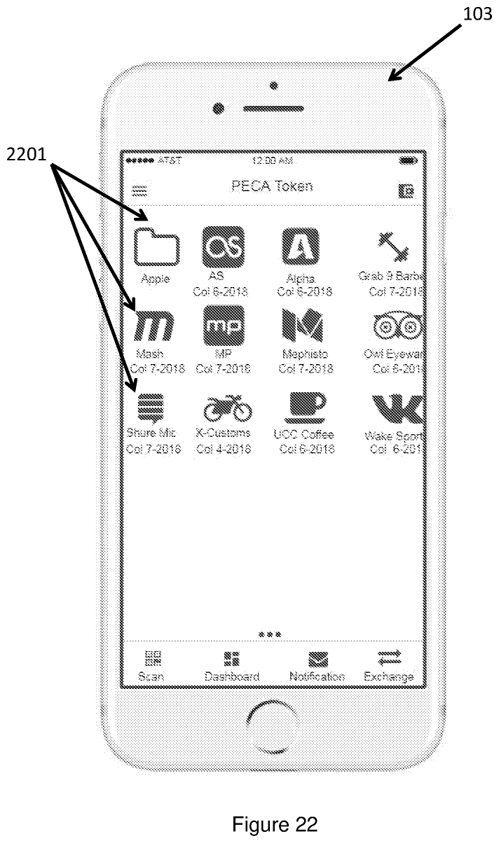

FIG. 22 illustrates all the asset-tokens issued by the respective merchants, i.e. PECA token, displayed on the reward-app interface.

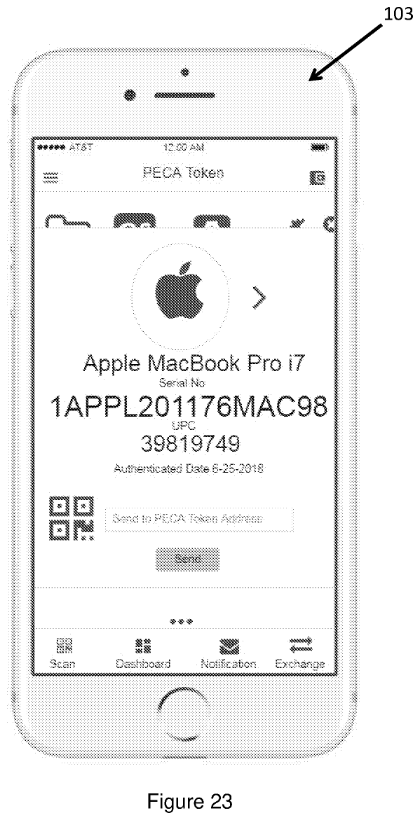

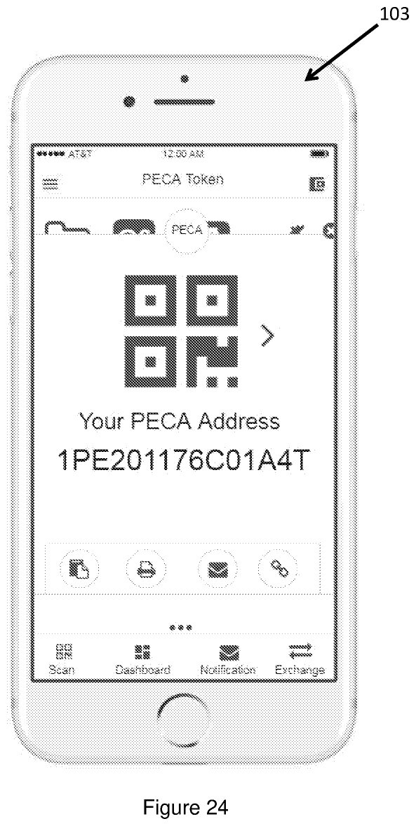

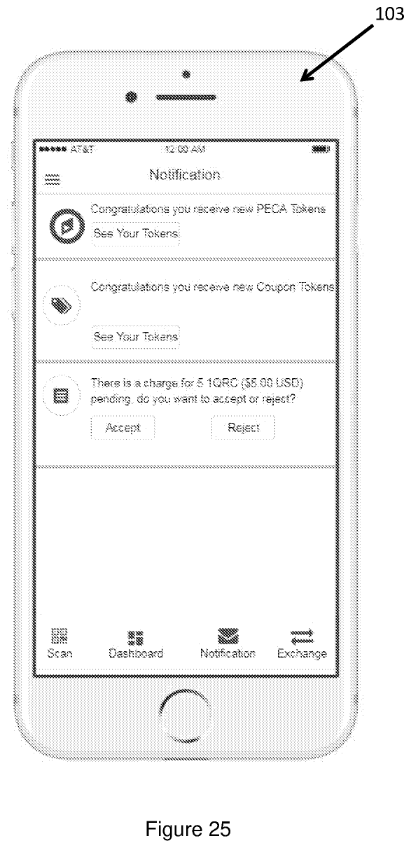

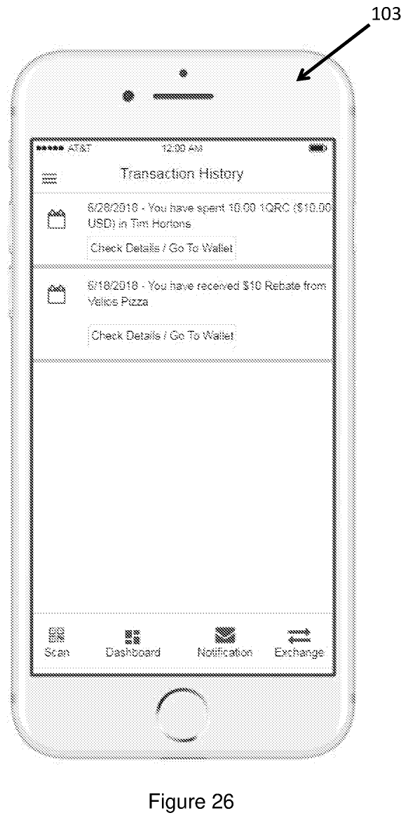

FIG. 23 shows an interface by which a first consumer can forward the asset-token to another consumer, such as if the other consumer has bought over a product 201 from the first consumer, and needs the asset-token to identify his ownership in order to avail to himself warranty and repair services. The other consumer who receives the asset-token will see the asset-token in the reward-app interface shown in FIG. 24. A confirmation message of the receipt is displayed in the interface of FIG. 25. FIG. 26 illustrates a reward-app interface for reviewing recent transactions of tokens, including asset-tokens, rebate-coupon-tokens 301 and so on.

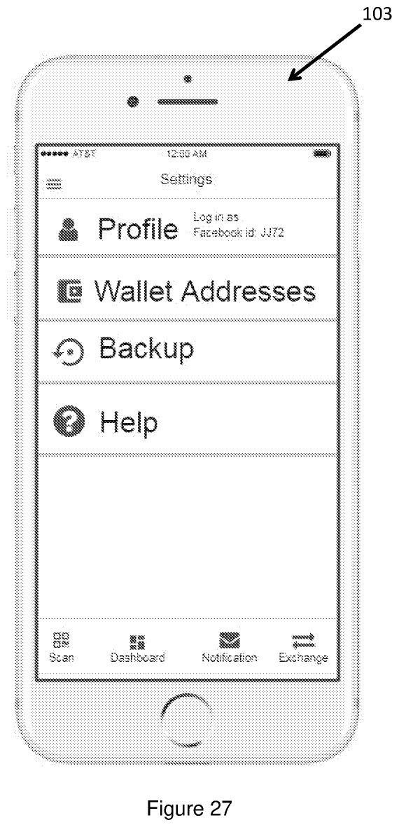

FIG. 27 shows the reward-app interface by which a consumer may view and amend his consumer profile in the embodiment.

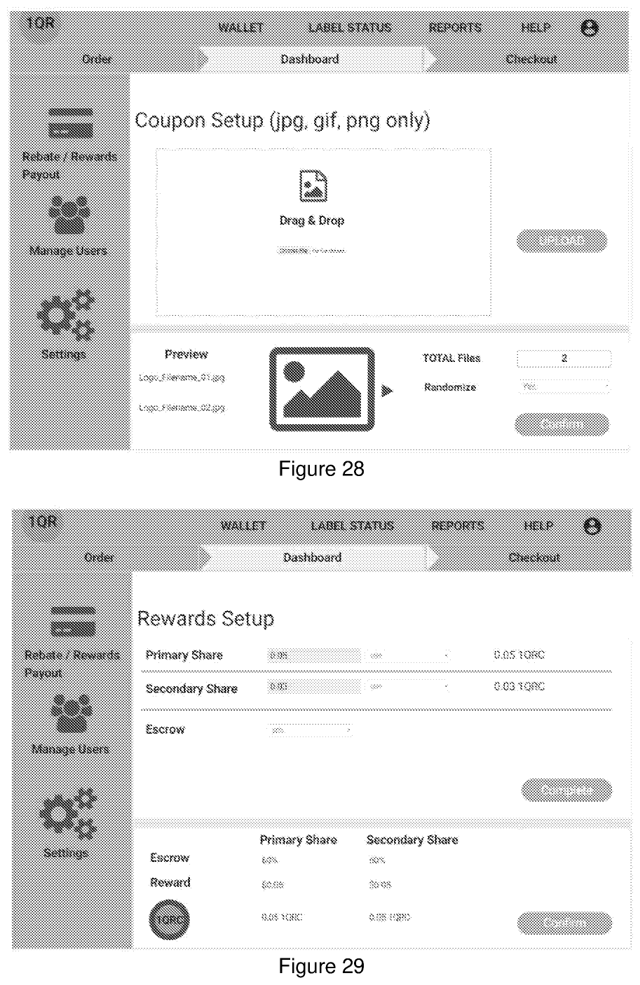

FIG. 28 shows part of the embodiment which is a merchant interface, meant for used by the merchant, not the consumer or the receiving contacts. The interface allows the merchant to setup and issue new digital tokens, be they for providing rebates or merely for advertising.

FIG. 29 shows a merchant interface for setting the amount of primary reward and the amount of secondary reward.

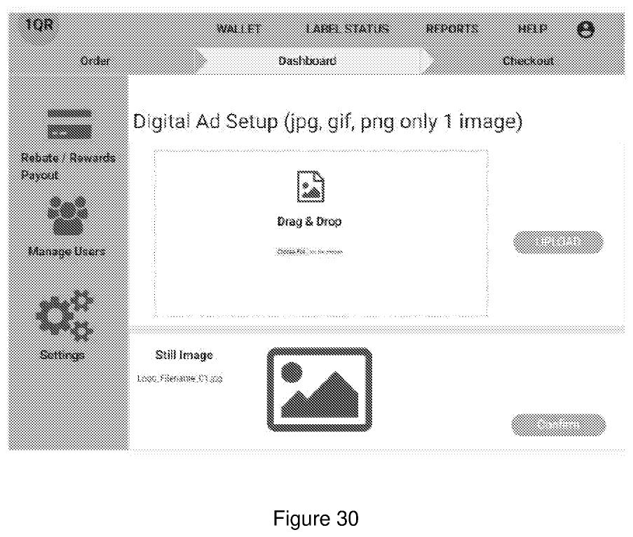

FIG. 30 shows a merchant interface for setting advertisement tokens.

A third embodiment will now be described and which comprises the following elements: smartphones 103 having a camera, a reward-app for smartphones, a social-media-platform app such as WeChat™ which is installed in the smartphones, a mini-program for WeChat™, QR codes tagged onto products of the merchant, and a blockchain system for storing records.

The reward-app provides functions for generating social-media-platform advertisement that is responsive to user clicks or user touch to issue rewards. The reward-app also contains a digital wallet for the smartphone owner to receive rewards and commissions in digital currency based on a blockchain system.

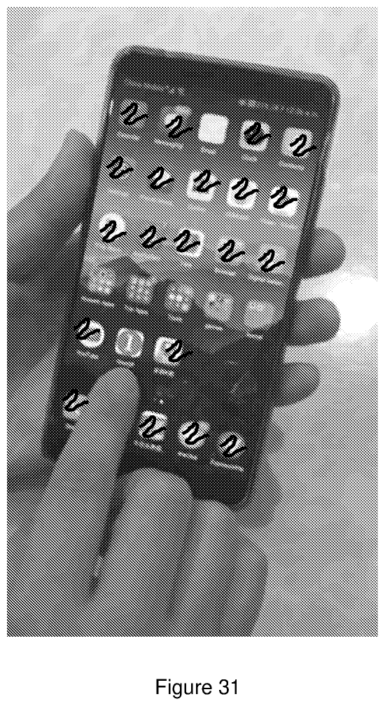

FIG. 31 to FIG. 35 are photographs taken of a prototype of the embodiment. The photographs show how a user is able to use the reward-app to create a picture that may be posted on WeChat™ to earn rewards for the user and people in his friend-list in WeChat™.

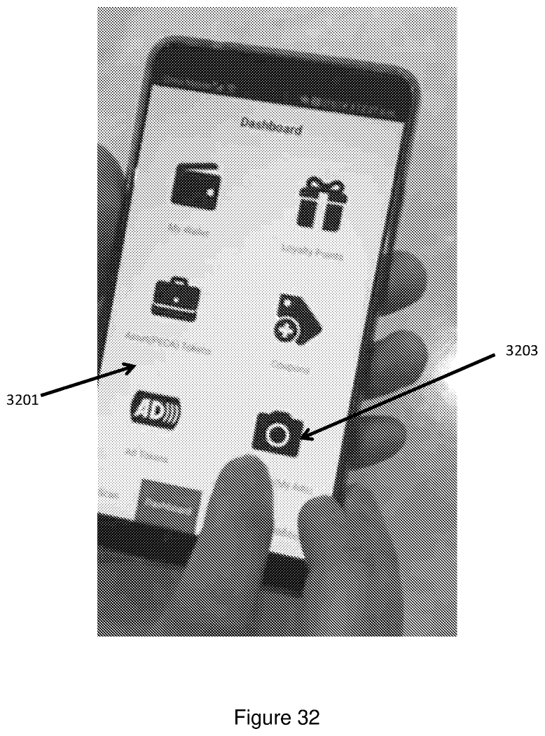

FIG. 31 shows the user with his finger just beneath the icon on the touchscreen display of a smartphone. Touching onto the icon launches the reward-app. FIG. 32 shows the reward-app 3201 opening up to display a dashboard. The reward-app 3201 contains a camera function which is triggered when the user presses onto the camera icon 3203 in the dashboard.

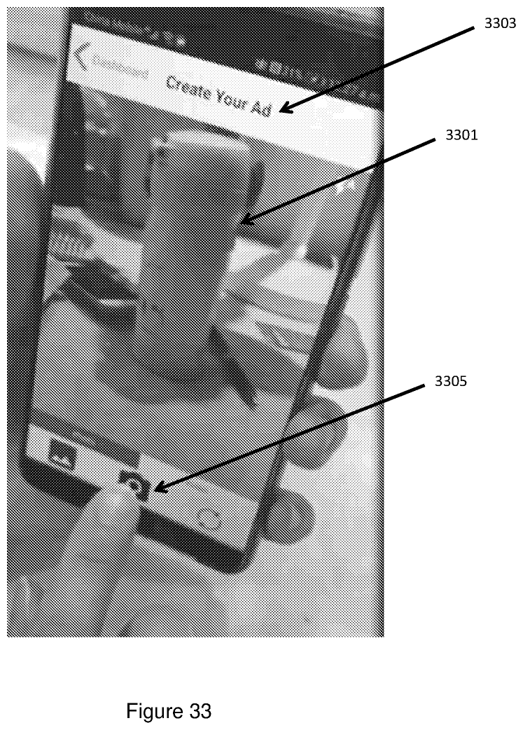

FIG. 33 shows the user aiming the camera of the smartphone at an object to take a picture 3301 which he intends to post onto his wall in WeChat™. The skilled man knows that by the word ‘wall’, it means a graphical display area of a social-media-platform, for showing textual, pictorial and video materials which the user published. Anyone who is a friend of the user's social-media-platform account is capable of seeing the material published on the wall of the user.

The picture 3301 can be a photograph of anything. The picture 3301 can be of a product which the user has just bought, a picture of the user himself, or a picture of a view from his window.

In FIG. 31, the picture is taken when the user presses onto a camera button 3305 in a Create You Ad frame 3303.

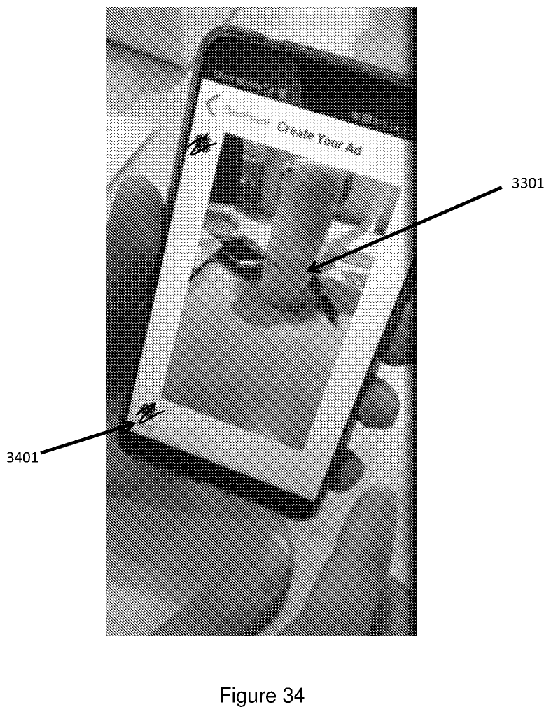

After the picture is taken, the Create Your Ad frame 3303 shows an array 3401 of merchants' banners is displayed in the frame around the picture. FIG. 34 illustrates this schematically, by showing only one trademark 3401 for simplicity, but the skilled reader would know that the trademark 3401 illustrated represents an array of many merchants' banners that may be displayed.

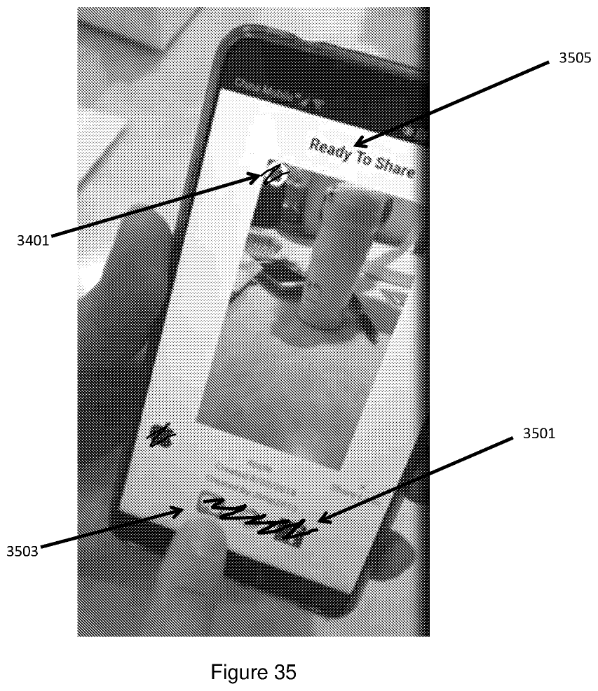

By touching onto a selected merchant's banner, the user causes a function in the reward-app to overlay the banner onto the picture 3301. The banner is an advertisement token afore-described in the earlier embodiments and contains an interactive hyperlink. After this, the Create Your Ad frame 3303 the changes in to a Ready To Share frame 3505 shown in FIG. 35.

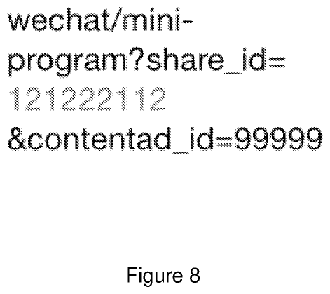

FIG. 8 illustrates the syntax of a link embedded in the advertisement token or banner.

Social media app icons 3501, representing the different social-media-platform apps which are installed in the smartphone, are then displayed at the bottom of the Ready To Share frame 3505. In the FIG. 35, the finger of the user is shown placed to touch a WeChat™ icon 3503 among the social media app icons 3501.

When the user touches the WeChat™ icon 3503, the picture 3601 is uploaded into the WeChat™ account of the user. People among the friend-list of the user's WeChat™ account can now see the picture posted onto the WeChat™ wall of the user.

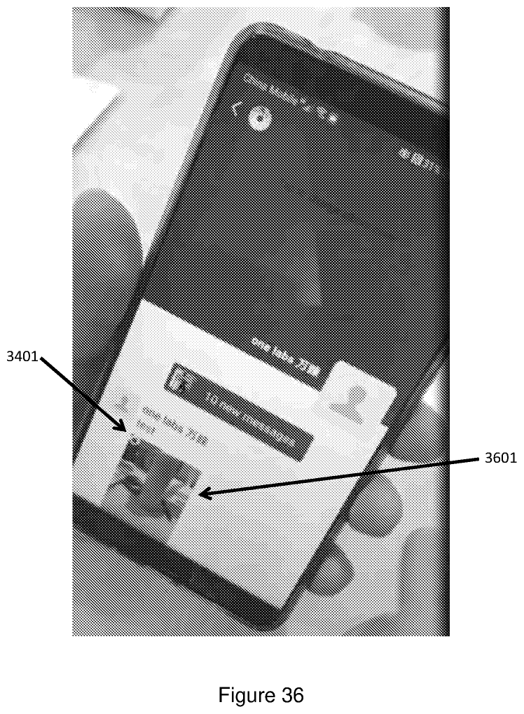

The friend, using a WeChat™ app in his own smartphone sees the picture posted on the WeChat™ wall of the user as shown in FIG. 36. As the advertising banner overlays the picture, when the friend looks at the picture on the user's WeChat™ wall, the friend notices the advertising banner.

The mini-program is written for WeChat™ and is installed into the WeChat app in the smartphones. As the skilled man knows, mini-programs are “sub-applications” for programs which can be written by any third party, and may installed into a social-media-platform app. Such a third party uses mini-programs to provide tailor-made functional features which are often used in e-commerce, task management, digital coupons and so on. Mini-programs can also be written for other social-media-platforms such as Facebook™.

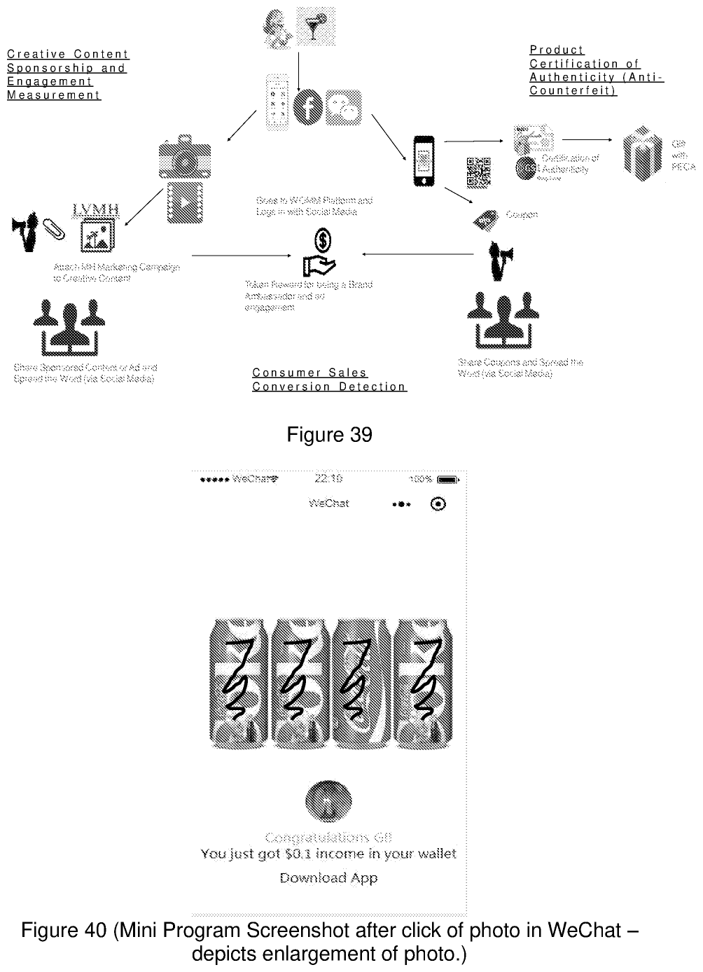

The friend's WeChat™ app is pre-installed with a mini-program. The present mini-program allows WeChat™ to detect people touching pictures displayed on WeChat™, by the touch sensitive screen of the smartphone, and allows the advertising token to react to the touch. When the user touches the picture, the mini-program obtains the social media identity of the friend, and records the identity into the blockchain along with information of the banner placed over the picture. In other words, the friend becomes a receiving contact. A reward is given to the friend for touching the picture, in the form of digital currency (also illustrated in FIG. 39). Hence, the WeChat™ users are encouraged to touch onto as many pictures posted by others as possible to earn rewards.

As in the afore-described embodiments, the mini-program allows only each first-time touch on the picture to provide a reward. Any a friend touches the picture displayed by WeChat™ on the user's wall in the friend's smartphone, the mini-program checks if there is any record in the blockchain of identity of the friend matched to the advertising token. If there is no such record, a reward is given to the friend. If there is such a record, no reward is given. Therefore, any repeated touching onto the same advertising token by the same friend using the same smartphone will not give any reward. This provides that advertisement is only charged for one touch by every friend.

When the friend touches onto the picture for the first time, 30% of the pre-determined commission is given to the user who initiated the banner, into his digital wallet. The commission may be 10 dollars. The friend only receives the afore-mentioned reward, which may be 10 cents.

The friend buys a product from the merchant's business subsequently. The product is tagged with a QR code 203, which the friend scans using the reward-app and the camera in the smartphone. The OR code 203 has been pre-recorded as belonging to the merchant.

The reward-app recognises the QR code 203 and does two things. Firstly, the reward-app shows a message to the friend verifying that the product is authentic and not a counterfeit. This is to encourage a culture of seeking product authentication and also to encourage the friend to use the reward-app. Secondly, the reward-app checks whether the blockchain has a record of the friend's phone identity matched to the merchant's banner, which has been recorded when the friend touched the user's picture for the first time. If the blockchain has a record of the friend's phone identity matched to the merchant's banner, the reward-app assumes that the purchase is made because the friend is influenced by the user's picture. The reward-app then sends the remaining 70% of the commission into the user's digital wallet. In this way, the user obtains a full commission for having facilitated the purchase by posting the picture with the banner.

The reward-app then sends the friend a coupon to encourage the friend to make future purchases.

The embodiment encourages people to click onto pictures overlaid with advertising banners in WeChat™, as they are rewarded in digital currency each time they click on the pictures. In this way, the embodiment encourages attention to be paid to advertisements.

The embodiment also encourages the user to post the picture and informs his friends who are likely to buy the merchant's products to touch the picture. Hence, this propagates target marketing.

Furthermore, the embodiment encourages the friend to re-post the same picture on his own wall, i.e. on the friend's WeChat™ account. If a friend of the friend, i.e. a second friend, touches the picture posted on the friend's WeChat™, both the second friend and the friend get a reward in digital currency. The user has already received the 30% commission and is only awaiting someone who has touched a copy of his picture in WeChat™ to make an actual product purchase and to scan the product's QR code.

The relationship between all the people who re-post the picture on their own WeChat™ all is linear. If the second friend re-posts the picture on the wall of his WeChat™ account, and a third friend sees and touches the picture, the third friend, the second friend and the friend each gets a reward in digital currency. The length of the chain of friends can be unlimited. Each time the last person in the chain touches the picture, which is by now posted on the wall of the WeChat™ account belonging to someone just preceding the last person in the chain, every friend in the chain gets a reward except the user. The user has already gotten his 30% commission when the first friend in the chain touched the picture.

Alternatively, to control the amount of reward to be paid out, the reward is only limited to the first three friends in the chain. When the fourth friend in the chain touches the picture posted on the WeChat™ wall of a third friend, the fourth friend's touch does not result in any reward for himself or anyone. Similarly, a fifth friend in the chain touching the picture posted on the WeChat™ wall of the fourth friend will not result in any new reward for anyone.

However, when anyone in the chain of friends buys a product from the merchant, and as soon as that friend scans the attached OR code attached to the merchant's product using the reward-app, the reward-app updates the blockchain records to expire the advertising token for the entire chain of friends. This is because the banner has fulfilled its purpose of attracting one purchase. The user who has initiated the chain gets the remaining 70% commission.

The user will have to post another picture with a new banner to generate another reward chain.

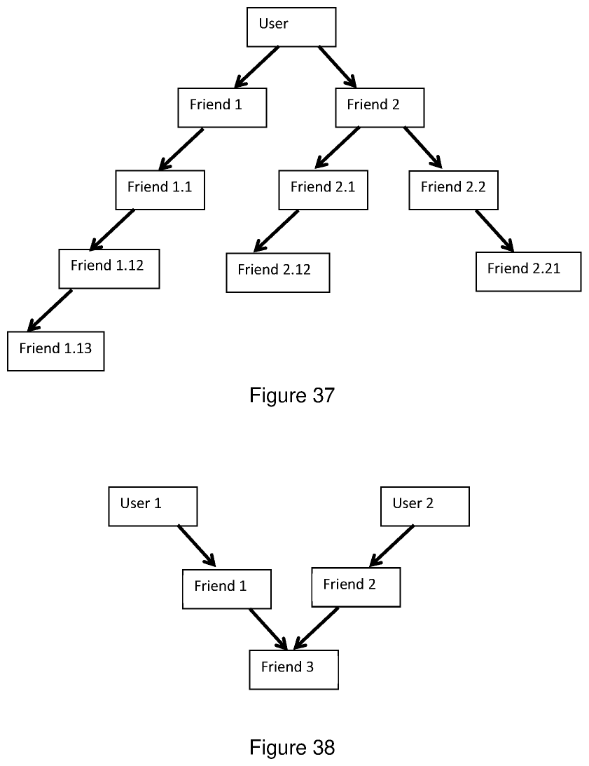

If two friends take the picture from the user's WeChat™ all and reposts the picture on their respective WeChat™ walls, a new chain is branched off. FIG. 37 explains this branching graphically. When the user posts the picture onto his WeChat™ wall, and two of his friends, Friend 1 and Friend 2, touch the picture, one of these two friends will trigger a new linear chain. The other of these two friends simply propagates the original chain. At the same time, Friend 1 and Friend 2 gets a reward each, and the user gets two 30% commissions.

From Friend 1, Friend 1.1, Friend 1.12 to Friend 1.13, a linear chain is illustrated, as each of them adds himself to the chain by re-posting the picture taken from the wall of the respective preceding friend. Each time a friend touches the picture for the first time, he gets a reward.

Friend 2 is the first in a new chain, a chain which is different from the one which Friend 1 is in. If two of the friends among the friend-list of Friend 2 copy the picture from the wall of Friend 2, and each of them re-posts the picture on his own wall, one of these two friends is added to the existing chain, while the other one branches off a new chain. A new 30% commission is paid to the user for the new branch.

Therefore, as illustrated in FIG. 37, each of Friend 2, Friend 2.1, and Friend 2.12 adds himself to a chain by re-posting the picture taken from the wall of the respective preceding friend. Similarly, each of Friend 2, Friend 2.2, and Friend 2.21 adds himself to a chain by re-posting the picture on the wall of the respective preceding friend.

Accordingly, Friend 1 by touching the picture on the user's wall, Friend 2 by touching the picture on the user's wall, and Friend 2.1 by touching the picture on Friend 2's wall, all trigger a 30% commission to the user. That is, there are three sets of commission. Friend 2.2 merely propagates the existing chain from Friend 2 and does not trigger a new 30% commission to the user.

If Friend 2.12 buys a product of the merchant and scans the QR code attached to the product using the reward-app, the reward-app expires the chain formed by Friend 2.1 and Friend 2.12. Friend 2.1 then gets a coupon to encourage further purchase, while the user gets the remaining 70% commission. The chains of Friend 2, Friend 2.2 and Friend 2.21, and the chain of Friend 1, Friend 1.1, Friend 1.12 and Friend 1.13 remain in existence, waiting for a purchase to be made by someone in these chains to reward the user.

Accordingly, each linear chain is expired only when someone in the chain buys a product from the merchant.

FIG. 38 illustrates the case when someone, Friend 3, touches two pictures initiated by different users. Each of the two pictures is overlaid with a banner from the same merchant. However, as the two pictures were initiated by different users, the advertisement tokens in the pictures are different, e.g. have different token identity numbers, even if the advertisement messages displayed in the banners are identical.

When Friend 1 touches the picture initiated by User 1, User 1 gets 30% commission, and Friend 1 gets a reward. When Friend 2 touches the picture initiated by User 2, User 2 gets 30% commission, and Friend 2 gets a reward.

Friend 3 then touches the picture on the WeChat™ wall of Friend 1 to get one reward. Friend 3 also touches the picture on the WeChat™ wall of Friend 2 to get another reward.

If Friend 3 buys a product from the merchant and scans the product's OR code with the reward-app in this smartphone to authenticate the product, the reward-app expires both chains because Friend 3 is matched with two different advertisement tokens in the blockchain records, from two different banners from the same merchant. User 1 and User 2 each gets the remaining 70% commission. Friend 3 then gets two coupons from the merchant to encourage future spending.

FIG. 39 shows the full third embodiment and the relationships between all the parties. On the left side of the chart in FIG. 39 is the third embodiment, and on the right side of the chart in FIG. 39 is the first embodiment.

FIG. 40 shows a screen which pops up in the third embodiment when a friend touches onto the advertising banner, to show the friend that he has earned a reward.

Accordingly, the described embodiments comprises a method of denying duplicate reward for dissemination of information comprising the steps of: providing a digital token (which could be either an asset-token 1205 or a rebate-coupon-token 301, or both) on the social-media-platform account of a user, the digital token bearing the information; the user forwarding the digital token to a contact in his social-media-platform account, such that if the contact accepts the digital token, the social-media-platform account of the contact is paired with the digital token, wherein a reward is issued to the user each time a social-media-platform account of the contact is paired with the digital token; the user forwarding the digital token to the same contact a second time; identifying the second time as an second attempt to pair the social-media-platform account of the same contact with the digital token, and denying a second pairing of the social-media-platform account of the contact with the digital token. Typically, the information is advertisement.

Also, in other words, the embodiments comprises a system 100 for monitoring purchaser-relationship comprising: one or more products 201; each of the one or more products 201 being affixed with a machine-readable-code (such as the OR-code 203); each of the machine-readable-code being concealed by a removable concealer (such as the opaque sticker 205); if the purchaser removes the concealer, the machine-readable-code being capable of triggering a wireless communication device (such as a smartphone 103) to communicate with a server 101 when the wireless communication device reads the machine-readable-code; wherein, the communication with the server 101 comprises communicating information on a social-media-platform account of the user of the wireless communication device and on the product 201.

Furthermore, the embodiments comprises a method of identifying a second attempt in receiving information in a social-media-platform (such as on the website 303 of the social-media-platform) comprising the steps of: displaying a digital token (which could be either an asset-token 1205 or a rebate-coupon-token 301, or both) in the account of a user in an interface of a social-media-platform, the digital token comprising the information; determining if the digital token has been paired to the account of the user in a social-media-platform when a user interacts with the digital token; pairing the digital token to the account of the user in the social-media-platform if the digital token has not been paired to the account of the user in social media; or disregarding the user interaction if the digital token has been paired to the account of the user in social media.

Furthermore, the embodiments include a digital picture for display on a social-media-platform in a smartphone, the digital picture comprising: a digital token which is initiated by a user for a merchant; the digital token being responsive to use of the smartphone to verify a product sold by the merchant, such that on verification of the product, the digital token triggers payment of a commission to the user.

While there has been described in the foregoing description preferred embodiments of the present invention, it will be understood by those skilled in the technology concerned that many variations or modifications in details of design, construction or operation may be made without departing from the scope of the present invention as claimed.

For example, the embodiment can be implemented in complex variations. Hence, it is not feasible to provide illustration of all the possible user interfaces providing all the aforementioned functions.

Also, where advertisements have been mentioned, the advertisement could be textual and graphical display or a video display.

Furthermore, although a cover which may be peeled off a QR-code 203 has been described, other ways of concealing the QR-code 203 is possible For example, a product 201 seal made of hard plastic may be wrapped around the product 201 to prevent the QR-code 203 from being scanned or read properly by a smartphone 103. In this case, the product 201 seal it has to be cut open to expose the QR-code 203 for scanning.

‘Clicking’ on any advertisement or digital token includes using a mouse pointer, and a human using his finger to touch a display of the advertisement or digital token on a touch-screen.

1. A method of denying duplicate reward for dissemination of information comprising the steps of:
providing a digital token on the social-media-platform account of a user, the digital token bearing the information;
the user forwarding the digital token to a contact in his social-media-platform account, such that if the contact accepts the digital token, the social-media-platform account of the contact is paired with the digital token, wherein a reward is issued to the user each time a social-media-platform account of the contact is paired with the digital token;
the user forwarding the digital token to the same contact a second time;
identifying the second time as an second attempt to pair the social-media-platform account of the same contact with the digital token, and denying a second pairing of the social-media-platform account of the contact with the digital token.

2. A method of denying duplicate reward for dissemination of information as claimed in claim 1, further comprising the step of:
issuing an amount in digital currency to the user if an attempt to pair the social-media-platform account of the contact with the digital token is not identified as a second attempt.

3. A method of denying duplicate reward for dissemination of information as claimed in claim 1, wherein
the information is an advertisement.

4. A method of denying duplicate reward for dissemination of information as claimed in claim 1, wherein
records of the digital token are maintained in a blockchain.

5. A system for monitoring purchaser-relationship comprising:
one or more products;
each of the one or more products affixed with a machine-readable-code;
the machine-readable-code being capable of triggering a wireless communication device to communicate with a server when the wireless communication device reads the machine-readable-code; wherein,
the communication with the server comprises communicating information on a social-media-platform account of the user of the wireless communication device and on the product.

6. A system for monitoring purchaser-relationship as claimed in claim 5, wherein
the server is configured to issue a digital token to the user's account on the social-media-platform;
the digital token being capable of being forwarded to other accounts on the social-media-platform such that the server records the digital token against the other accounts.

7. A system for monitoring purchaser-relationship as claimed in claim 5, wherein
the machine-readable-code is a QR code capable of identifying the merchant who provides the product.

8. A system for monitoring purchaser-relationship as claimed in claim 5, wherein
the wireless devices are smartphones.

9. A method of identifying a second attempt in receiving information in a social-media-platform comprising the steps of:
displaying a digital token in the account of a user in an interface of a social-media-platform, the digital token comprising the information;
determining if the digital token has been paired to the account of the user in a social-media-platform when a user interacts with the digital token;
pairing the digital token to the account of the user in the social-media-platform if the digital token has not been paired to the account of the user in social media; or
disregarding the user interaction if the digital token has been paired to the account of the user in social media.

10. A digital picture for display on a social-media-platform in a smartphone, the digital picture comprising:
a digital token which is initiated by a user for a merchant;
the digital token being responsive to use of the smartphone to verify a product sold by the merchant, such that
on verification of the product, the digital token triggers payment of a commission to the user.

11. A digital picture for display on a social-media-platform in a smartphone as claimed in claim 10, wherein
the digital token triggers payment of a reward to any person who has posted the picture on his account in the social-media-platform when a viewer of the person's social-media-platform interacts with the picture.

12. A digital picture for display on a social-media-platform in a smartphone as claimed in claim 10, wherein
the digital token is extinguished for every person in a linear chain of persons who has re-posted a copy of the picture onto his account in the social-media-platform when anyone of the persons in the chain verifies a product sold by the merchant.

13. A digital picture for display on a social-media-platform in a smartphone as claimed in claim 10, wherein
the digital token is contained in an information banner that is overlaid onto the digital picture.

14. A digital picture for display on a social-media-platform in a smartphone as claimed in claim 13, wherein
the information banner contains advertisement.
